(19) United States
(12) Patent Application Publication
(10) Pub. No.: US 2005/0282958 A1
(43) Pub. Date: Dec. 22, 2005

(54) Coating composition of positive photosensitive polyimide

(75) Inventors: Jyh-Long Jeng, Hsinchu (TW); Jinn-Shing King, Hsinchu (TW); Charng-Shing Lu, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/868,821

(22) Filed: Jun. 17, 2004

(51) Int. Cl. C08K 3/00

(52) U.S. Cl. 524/606

(57) ABSTRACT

A coating composition of positive photosensitive polyimide is disclosed, which includes an organic solvent and the following components dissolved in the organic solvent: (a) a polyimide having a phenolic hydroxyl group or carboxyl group at the end of a principal chain of the polymer; (b) a compound having a phenolic hydroxyl group; and (c) a quinonediazide sulfonate as a photosensitive agent. The amount of the components (b) and (c) are 1-50 parts by weight per 100 parts by weight the component (a) in the coating composition. A film of the coating composition can be developed with an alkaline aqueous solution, which has a high photosensitivity, excellent resolution, low post-cure temperature, high film residual rate in thickness, and a pattern having a tapered-angle at the cross section. The coating solution can be used for forming an insulating layer in displays or in other suitable applications.

### FIELD OF THE INVENTION

The present invention relates to a coating composition of positive photosensitive polyimide, which is applicable as an insulating layer in displays.

### BACKGROUND OF THE INVENTION

Due to its excellent thermal stability and good mechanical, electrical and chemical properties, polyimide (PI) is widely used in semiconductor and display industries, e.g. encapsulation film of IC chip, and insulator in chip scale package (CSP) and display, etc. Since the use of photosensitive polyimide (PSPI) can provide simplification of fabrication processes, reduction of cost and a higher yield, the use of PSPI has become a trend.

There are numerous publications related to PSPI. However, most of them are related to precursors of polyimide, e.g. poly(amic ester), such as those disclosed in U.S. Pat. No. 6,329,110, U.S. Pat. No. 6,291,619, U.S. Pat. No. 6,232,032 and U.S. Pat. No. 5,858,584, etc. The pattern developed by poly(amic ester) is a standard rectangle. However, the insulating layer in a display needs to have a pattern with tapered-angle at the cross section disclosed in U.S. Pat. No. 6,222,315. Furthermore, the poly(amic ester) needs to be imidized at 350° C. which is in conflict with the requirement of process temperature of lower than 250° C. Thus, PSPI made from poly(amic ester) is not feasible. Imidized PSPI has been disclosed, e.g. U.S. Pat. No. 6,627,377, U.S. Pat. No. 5,441,845, U.S. Pat. No. 5,5738,86, etc. Although, such imidized PSPI has a lower post-cure temperature, usually it is a soluble PI with a generally poor solvent resistance. Furthermore, such imidized PSPI needs to be developed with an alkaline solution having a high concentration, and thus is not suitable.

Masao Tomikawa et al. in Journal of Photopolymer Science and Technology, 2002, 15, 205˜208, U.S. Pat. No. 6593043 and U.S. Pat. No. 6,524,764 have disclosed a positive-type photosensitive polyimide presursor composition comprising a poly(amic ester) having phenolic hydroxyl group at the ends of the main chain thereof and a compound having phenolic hydroxyl group as the crosslinking agent, such that the pattern formed has a tapered-angle at the cross section. However, the main structure of the polyamic acid ester still needs to be imidized at a high temperature in order to ensure a complete imidization. Examples 6-13 of U.S. Pat. No. 6,524,764 show that shrinkage takes place when the polyamic acid ester is converted to polyimide. As a result, the film thickness retention rate of the PSPI formed from polyamic acid ester is low (66%). Further, the synthesis of the poly(amic ester) having phenolic hydroxyl group at the ends of the main chain thereof is complicated.

### SUMMARY OF THE INVENTION

One objective of the present invention is to provide a novel coating composition of positive photosensitive polyimide, which can be synthesized easily, developed by an alkaline aqueous solution in a short time, and has a high sensitivity, good resolution, low post-cure temperature, high film thickness retention rate, and a tapered-angle at the cross section after post-cure. The invented coating composition can be stored stably at room temperature.

A positive photosensitive polyimide coating composition prepared according to the present invention comprises an organic solvent and, dissolved in said organic solvent, (a) a polyimide having a phenolic hydroxyl group or carboxyl group at an end of a principal chain of the polymer, (b) a compound having a phenolic hydroxyl group, and (c) a quinonediazide sulfonate as a photosensitive agent, wherein the amount of the component (b) is 1-50 parts by weight per 100 parts by weight of the component (a) in the coating composition, and the amount of the component (c) is 1-50 parts by weight per 100 parts by weight of the component (a) in the coating composition.

Preferably, said polyimide (a) has the following structure (1) or (2): 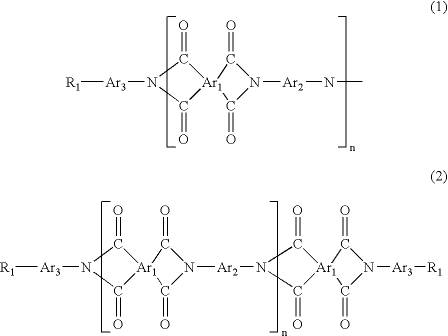
wherein n is an integer of 10-600, Ar₁ is a tetra-valent organic group, Ar₂ is a bi- to tetra-valent organic group, Ar3 is a bi-valent aryl, R1 is OH group or COOH group.

More preferably, Ar₃ in the structures (1) and (2) is

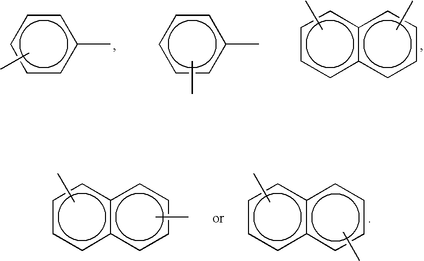

Ppreferably, Ar₁ in the structures (1) and (2) is

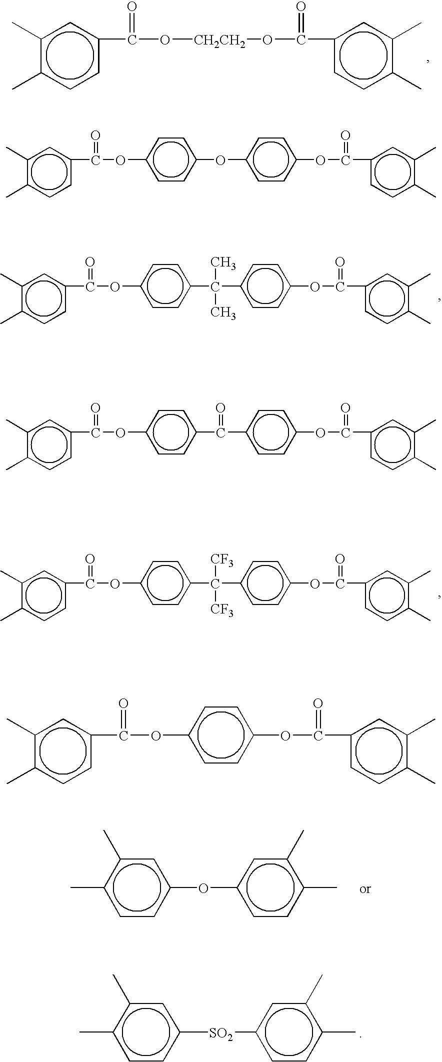

Preferably, Ar₂ in the structures (1) and (2) is 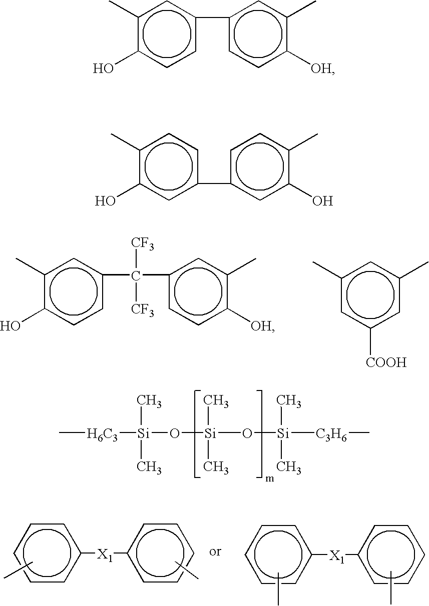
wherein m is an integer of 1-20, and X₁ is 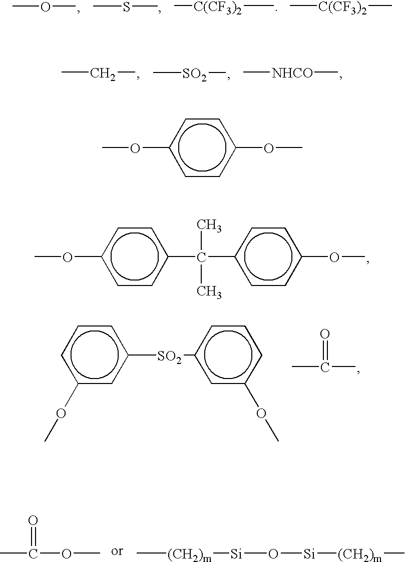
wherein m is an integer of 1-20, and Z is H or methyl.

Preferably, the amount of the component (b) is 5-25 parts by weight per 100 parts by weight of the component (a) in the composition.

Preferalby, wherein said compound having a phenolic hydroxyl group (b) has the following structure: 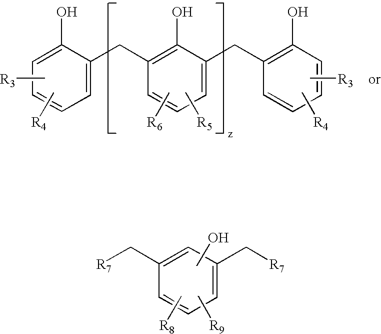
wherein R₃ to R₉ independently are H, —OH group, C₁-C₂₀ alkyl or C₄-C₂₀ cycloaliphatic group, and z is an integer of 0-5. More preferably, said compound having a phenolic hydroxyl group (b) is:

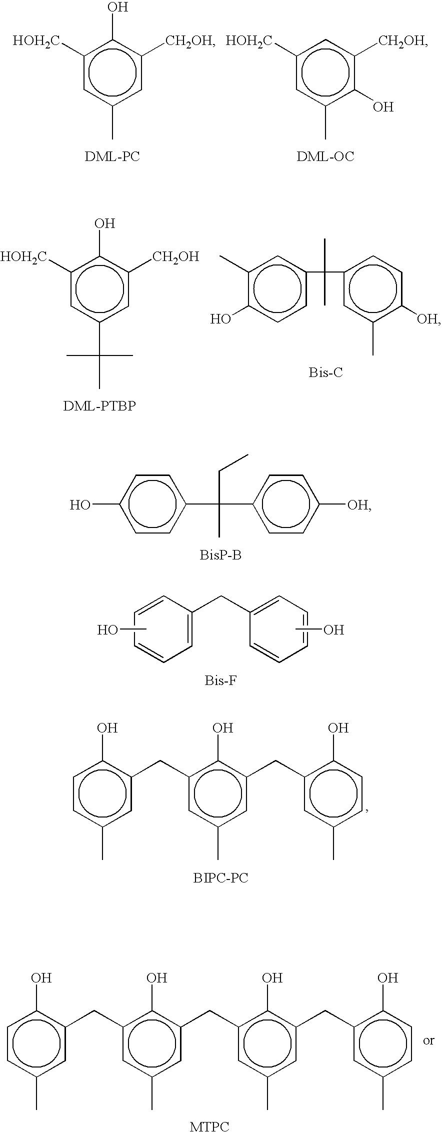

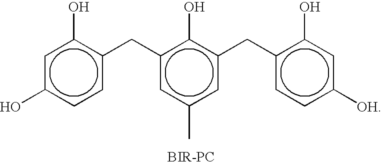

Preferably, the component (c) as a photosensitive agent has the following structure: 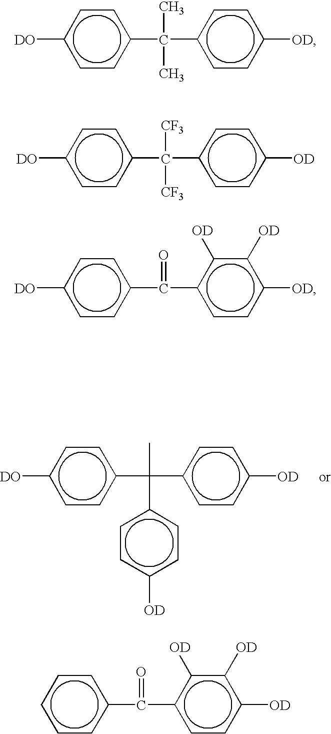
wherein D of each occurrence is hydrogen, 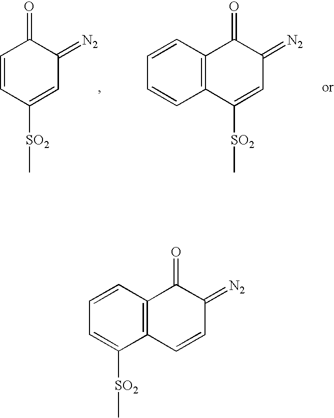
provided that not all occurrences of D are hydrogen.

Preferably, the total weight of components (a), (b) and (c) is 5-50% of the total weight of said composition.

Preferalby, said organic solvent is N-methyl-2-pyrrolidone, γ-butyrolactone, or ethyl lactate.

### BRIEF DESCRIPTION OF THE DRAWINGS

FIGS. 1a and 1b separately show the scanning electron microscope (SEM) photos of top view and cross-sectional view of the pattern by using the positive photosensitive polyimide coating composition prepared in Example 1 of the present invention.

### DETAILED DESCRIPTION OF THE INVENTION

A polyimide suitable for use in the present invention may be synthesized by the following steps: dissolving a suitable amount of a diamine monomer and a dianhydride monomer in a suitable organic solvent, e.g. N-methyl-2-pyrrolidone (NMP); vigorously mixing the resulting mixture at 0˜4° C. for 4 hours; adding an endcapped agent (e.g. a primary amine with a phenoxyl or carboxyl group) into the mixture and stirring the mixture for 4 hours; adding xylene into the mixture and heating the mixture at 180° C. under refluxing for about 3 hours; and cooling the mixture to obtain a polyimide (PI) solution having a phenoxyl or carboxyl group at the end of the main chain thereof. A solution of photosensitive polyimide (PSPI) according to the present invention may be prepared by preparing a suitable amount of a PI solution, adding a crosslinking agent having phenolic hydroxyl group and a photosensitive agent, and optionally adding a solvent, such as NMP, γ-butyrolactone (GBL), or ethyl lactate, etc., into the solution in order to dilute the PSPI solution to a desired concentration for use.

A photolithographic process by using the PSPI solution of the present invention includes: (i) coating a PSPI solution on a suitable substrate by using a spin coating or other coating process; (ii) prebaking the coating; (iii) imagewise exposing the prebaked coating; (iv) developing the exposed coating; and (v) post-curing the developed coating, thereby obtaining a polyimide (PI) pattern. In step (i), a positive PSPI solution is coated on a suitable substrate, e.g. silicon substrate, glass, or ITO glass. A suitable coating technique includes, but not limited to, spin coating, roller coating, screen coating, curtain coating, dip coating, and spray coating. In a preferred embodiment according to the present invention, a layer resulting from the coating is prebaked at 70˜120° C. for a few minutes to evaporate the solvent contained therein. Next, the coated substrate is imagewise exposed to a photo irradiation under a photomask. The abovementioned photo irradiation includes, for example, X-ray, electron beam, UV ray, visible ray, or any photo source suitable for being used as a photo irradiation source.

After exposure, said coated substrate is subsequently developed with an alkaline aqueous developer solution to remove the exposed portion of said coating layer, so that the pattern of the photomask is transferred. Said alkaline aqueous developer solution may be an alkaline aqueous solution, e.g. an aqueous solution of an inorganic alkaline (potassium hydroxide, or sodium hydroxide), a primary amine (ethylamine), a secondary amine (diethylamine), a tertiary amine (triethylamine), or a quaternary ammonium salt (tetramethylammonium hydroxide), and preferably an aqueous solution of tetramethylammonium hydroxide (TMAH). Developing can be accomplished by immersion, spraying, or other known developing methods. The resulting patterned layer is subsequently washed with deionized water and post-cured at 180˜400° C. to remove residual solvent, thereby obtaining a polyimide pattern with a tapered-angle at the cross section.

The film residual rate is calculated according to the following formula:
film residual rate (%)=[(film thickness after post-cure)/(film thickness after prebake)]

The present invention can be better understood by the following examples, which are for illustrative only and not for limiting the scope of the present invention.
Chemical Agents: 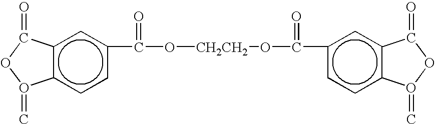
ethylene glycol bis(anhydro-trimellitate) (TMEG) 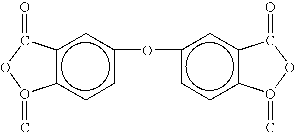
bis(3,4-dicarboxyphenyl)ether dianhydride (ODPA) 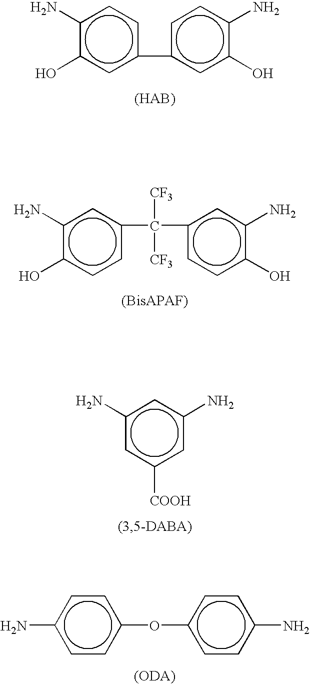
3,3-dihydroxybenzidine (HAB)
Hexofluoro-2,2-bis(3-amino-4-hydroxyphenyl) (BisAPAF)
3,5-diaminobenzoic acid (3,5-DABA)
4,4′-Oxydianiline (ODA) 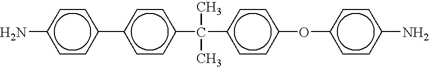
2,2-bis(4-(4-aminophenoxyl)phenyl)propane (BAPP) 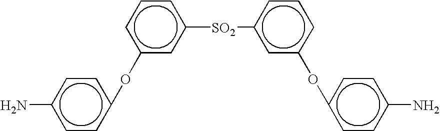
2,2-bis(4-(3-aminophenoxyl)phenyl)sulfone (m-BAPS) 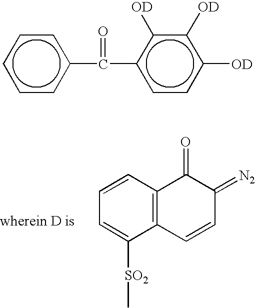
wherein D is
2,3,4-trihydroxy-benzophenone-1,2-diazonaphthoquinone-5-sulfonate (PIC-3, purchased from KOYO chemicals Inc.)
Crosslinking Agent:

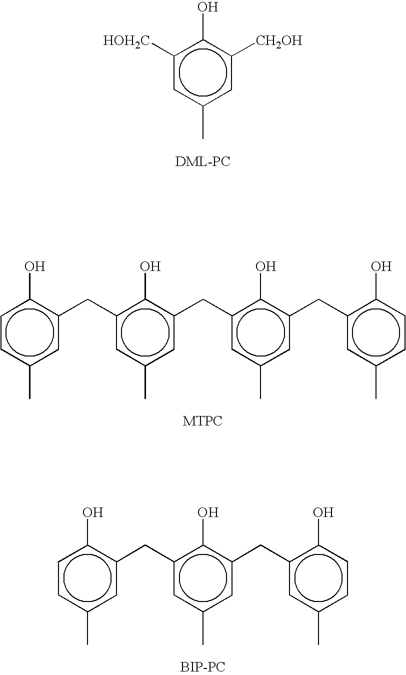

### EXAMPLE 1

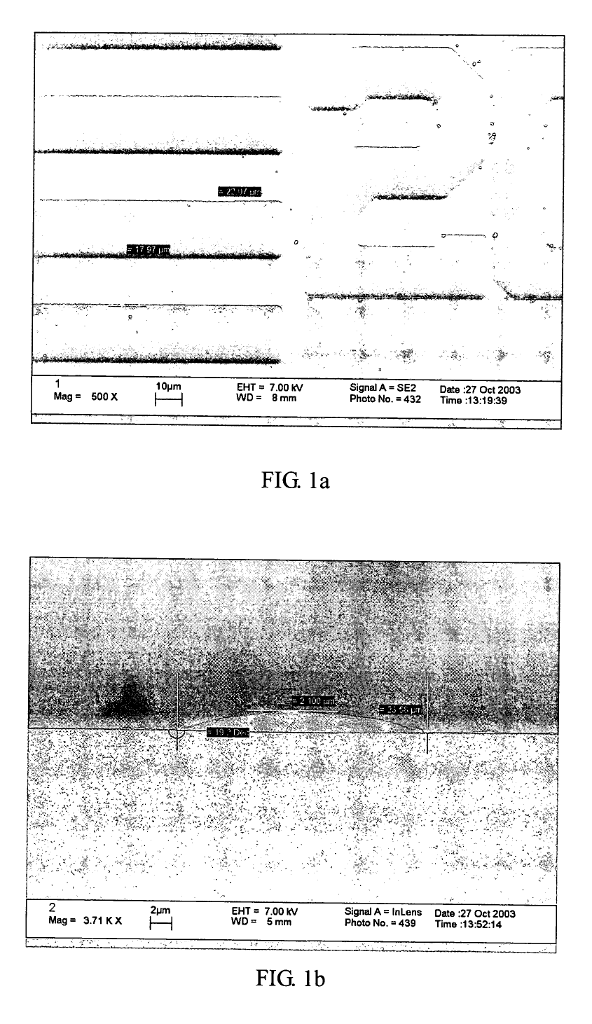

To a 1000-ml three-necked round bottom flask equipped with a mechanical stirrer 18.3 g (50 mmole) of Bis-APAF, 12.3 g (30 mmole) of BAPP, 2.02 g (10 mmole) of ODA, 20.5 g (50 mmole) of TMEG, 15.5 g (50 mmole) of ODPA, and 400 g of NMP as solvent were added. The resulting solution was stirred at 0° C. for 4 hours, and 2.18 g (20 mmole) of 3-aminophenol as an endcapped agent was then added, followed by 4-hour stirring at room temperature. To the stirred solution 80 g of xylene was added, and was heated to 180° C. for 3 hours while stirring. After cooling, a viscous PI solution PI-1 was obtained. An IR spectral analysis shows that the PI synthesized in this example has C═O and C—N characteristic absorptions at 1781 cm⁻¹ and 1377 cm⁻¹ of an imide group, respectively. To 50 g of PI-1 solution 1.875 g of PIC-3, and 1.875 g of DML-PC (crosslinking agent) were added. The resulting solution was mixed uniformly to obtain a photosensitive polyimide coating composition PSPI-1. A spin coating process was used to coat the PSPI-1 coating composition on for 2 minutes, thereby obtaining a film having a thickness of about 1.1 μm (measured by Talystep). The coated ITO glass was exposed by receiving a photo energy of about 100 mJ/cm² from an un-filtered mercury arc lamp (with measured wavelengths of 250˜400 nm), and then developed by 2.38 wt % tetramethylammonium hydroxide (TMAH) aqueous solution for 35 seconds. Next, the developed film received a post-cure process in an oven at 230° C. under circulation for 30 minutes in order to obtain a heat resistant PI pattern. As shown in FIG. 1a and FIG. 1b, the resulting pattern has a line width and pitch of about 20 μm and the taper angle is 19.2°. The film thickness after post-cure is 1.0 μm. Comparing the film thickness after post-cure with the film thickness after prebake, the film has 91% of film residual rate.

### EXAMPLE 2

To a 1000-ml three-necked round bottom flask equipped with a mechanical stirrer 7.6 g (50 mmole) of 3,5-DABA, 12.975 g (30 mmole) of m-BAPS, 1.54 g (7.5 mmole) of ODA, 32.8 g (80 mmole) of TMEG, 6.2 g (20 mmole) of ODPA, and 400 g of NMP as solvent were added. The resulting solution was stirred at 0° C. for 4 hours, and 2.73 g (25 mmole) of 3-aminophenol as an endcapped agent was then added, followed by 4-hour stirring at room temperature. To the stirred solution 80 g of xylene was added, and was heated to 180° C. for 3 hours while stirring. After cooling, a viscous PI solution PI-2 was obtained. To 50 g of PI-2 solution 1.875 g of PIC-3, and 1.0 g of MTPC (crosslinking agent) were added. The resulting solution was mixed uniformly to obtain a photosensitive polyimide coating composition PSPI-2. A spin coating process was used to coat the PSPI-2 coating composition on an ITO glass, followed by a prebake process by using a hot-plate at 110° C. for 2 minutes, thereby obtaining a film having a thickness of about 1.1 μm. The coated ITO glass was exposed by receiving a photo energy of about 120 mJ/cm² from an un-filtered mercury arc lamp (with measured wavelengths of 250˜400 nm), and then developed by 2.38 wt % TMAH aqueous solution for 35 seconds. Next, the developed film received a post-cure process in an oven at 230° C. under circulation for 30 minutes in order to obtain a heat resistant PI pattern. The resulting pattern has a line width and pitch of about 15 μm. The film thickness after post-cure is 0.95 μm. Comparing the film thickness after post-cure with the film thickness after prebake, the film has 86% of film residual rate. The resulting PI pattern has a tapered-angle at the cross section as shown in the SEM photo.

### EXAMPLE 3

To a 1000-ml three-necked round bottom flask equipped with a mechanical stirrer 10.8 g (50 mmole) of HAB, 12.975 g (30 mmole) of m-BAPS, 2.02 g (10 mmole) of ODA, 41.0 g (100 mmole) of TMEG, and 400 g of NMP as solvent were added. The resulting solution was stirred at 0° C. for 4 hours, and 2.18 g (20 mmole) of 3-aminophenol as an endcapped agent was then added, followed by 4-hour stirring at room temperature. To the stirred solution 80 g of xylene was added, and was heated to 180° C. for 3 hours while stirring. After cooling, a viscous PI solution PI-3 was obtained. To 50 g of PI-3 solution 1.875 g of PIC-3, and 2.25 g of BIPC-PC (crosslinking agent) were added. The resulting solution was mixed uniformly to obtain a photosensitive polyimide coating composition PSPI-3. A spin coating process was used to coat the PSPI-3 coating composition on an ITO glass, followed by a prebake process by using a hot-plate at 110° C. for 2 minutes, thereby obtaining a film having a thickness of about 1.2 μm. The coated ITO glass was exposed by receiving a photo energy of about 120 mJ/cm² from an un-filtered mercury arc lamp (with measured wavelengths of 250˜400 nm), and then developed by 2.38 wt % TMAH aqueous solution for 40 seconds. Next, the developed film received a post-cure process in an oven at 230° C. under circulation for 30 minutes in order to obtain a heat resistant PI pattern. The resulting pattern has a line width and pitch of about 15 μm and a film thickness of about 1.05 μm. Comparing the film thickness after post-cure with the film thickness after prebake, the film has 87.5% of film residual rate. The resulting PI pattern has a tapered-angle at the cross section as shown in the SEM photo.

### COMPARATIVE EXAMPLE 1

To a 1000-ml three-necked round bottom flask equipped with a mechanical stirrer 36.6 g (100 mmole) of Bis-APAF, 31.0 g (100 mmole) of ODPA, and 400g of NMP as solvent were added. The resulting solution was stirred at 0° C. for 4 hours, and 80 g of xylene was then added, and was heated to 180° C. for 3 hours while stirring. After cooling, a viscous PI solution PI-C1 was obtained. To 50 g of PI-C1 solution 1.8 g of PIC-3 was added. The resulting solution was mixed uniformly to obtain a photosensitive polyimide coating composition PSPI-C1. A spin coating process was used to coat the PSPI-C1 coating composition on an ITO glass, followed by a prebake process by using a hot-plate at 110° C. for 2 minutes, thereby obtaining a film having a thickness of about 1.1 μm. The coated ITO glass was exposed by receiving a photo energy of about 120 mJ/cm² from an un-filtered mercury arc lamp (with measured wavelengths of 250˜400 nm), and then developed by 2.38 wt % TMAH aqueous solution. After being developed for more than 3 minutes, a pattern still could not be obtained. An endcapped agent was not used for the synthesis of PI-C1 in comparative example 1.

### COMPARATIVE EXAMPLE 2

To 50 g of PI-1 solution prepared in Example 1 1.875 g of PIC-3 was added. The resulting solution was mixed uniformly to obtain a photosensitive polyimide coating composition PSPI-C2. The photophotolithographic procedures in Example 1 were repeated, except that the developing time was 60 seconds. The film thickness after prebake is about 1.0 μm, and the post-baked pattern has a line width and pitch of about 20 μm and a film thickness of 0.8 μm (with a film residual rate of 80%). A SEM photo indicates that the cross-section of the PI pattern is rectangular without tapered-angle at the cross section. A crosslinking agent, a compound having a phenolic hydroxyl group, was not used in the preparation of the photosensitive polyimide coating composition PSPI-C2 in Comparative example 2.

### COMPARATIVE EXAMPLE 3

Synthesis of HAB-ODPA-butanol-polyamic acid ester

To a 250-ml three-necked round bottom flask equipped with a mechanical stirrer and a nitrogen inlet 15.50 g (50 mmole) of ODPA, 7.40 g (100 mmole) of n-butanol, and 115 g of NMP as solvent were added. The resulting solution was heated to 80° C. and stirred for 4 hours for carrying out an esterification reaction. After the solution was cooled to 4° C., 16.63 g (200 mmole) of pyridine and 19.50 g (100 mmole) of phenylphosphonic dichloride were added, and the resulting solution was stirred at room temperature for 2 hours for carrying out an activation reaction of COOH group. The resulting solution was cooled to 0˜4° C., and 10.8 g (50 mmole) of HAB was added, which was then stirred at 0˜4° C. for 1 hour, and at room temperature for 8 hours for carrying out a polymerization reaction of polyamic acid ester. 1000 ml of methanol was added to form a precipitate in the reaction solution, the resulting precipitate was filtered out to obtain the polyamic acid ester. The collected polymer was washed with deionized water three times. Finally, the polyamic acid ester collected was dried in vacuo at 80° C. for 24 hours. 5 g of the resulting polyamic acid ester, 1.25 g of PIC-3, and 18.75 g of NMP as solvent were used to prepare a photosensitive polyimide precursor coating composition PSPI-C3. The photolithographic procedures in Example 1 were repeated, except that the developing time was 60 seconds. The film thickness after prebake is 1.0 μm, and the post-baked pattern has a line width and pitch of about 20 μm and a film thickness of 0.7 μm. Comparing the film thickness after post-cure with the film thickness after prebake, the film has 70% of film residual rate. Said film has a rectangular cross-section.

Said composition prepared in Comparative example 3 is an ordinary photosensitive polyimide precursor coating composition. Comparative example 3 is to emphasize that the conventional photosensitive polyimide precursor coating composition requires a post-cure treatment at 350° C. and has a lower film residual rate.

1. A positive photosensitive polyimide coating composition comprising an organic solvent and, dissolved in said organic solvent, (a) a polyimide having a phenolic hydroxyl group or carboxyl group at an end of a principal chain of the polymer, (b) a compound having a phenolic hydroxyl group, and (c) a quinonediazide sulfonate as a photosensitive agent, wherein the amount of the component (b) is 1-50 parts by weight per 100 parts by weight of the component (a) in the coating composition, and the amount of the component (c) is 1-50 parts by weight per 100 parts by weight of the component (a) in the coating composition.

2. The composition as claimed in claim 1, wherein said polyimide (a) has the following structure (1) or (2): 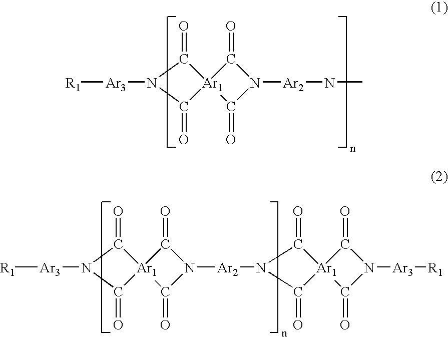
wherein n is an integer of 10-600, Ar₁ is a tetra-valent organic group, Ar₂ is a bi- to tetra-valent organic group, Ar3 is a bi-valent aryl, R1 is OH group or COOH group.

3. The composition as claimed in claim 2, wherein Ar₃ is

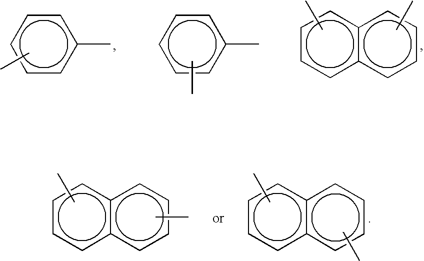

4. The composition as claimed in claim 2, wherein Ar₁ is

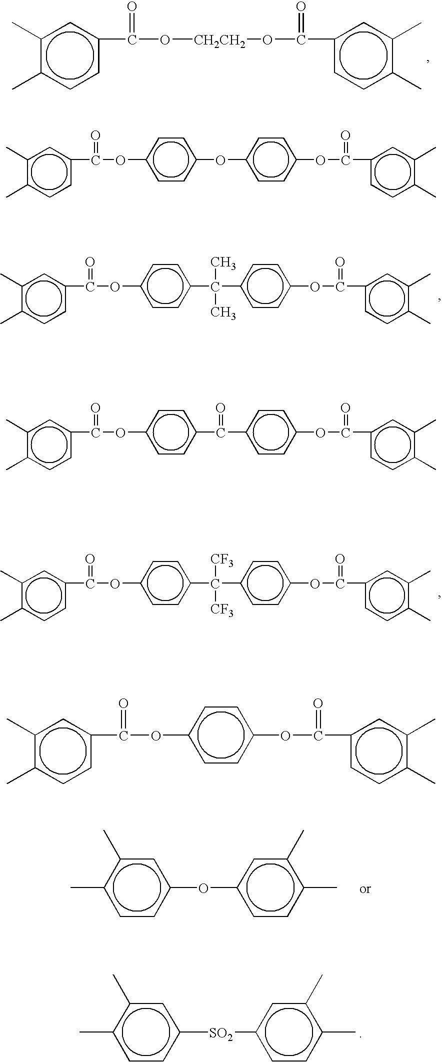

5. The composition as claimed in claim 3, wherein Ar₁ is

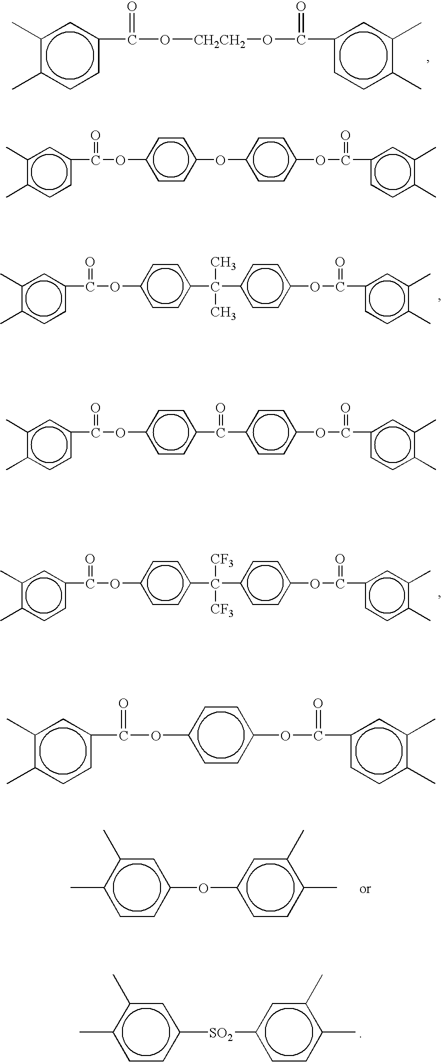

6. The composition as claimed in claim 2, wherein Ar₂ is 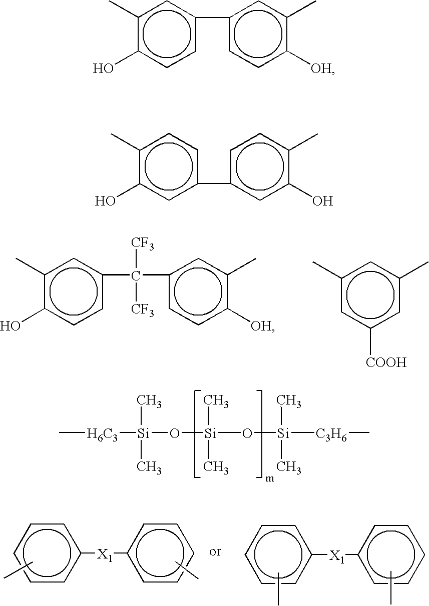
wherein m is an integer of 1-20, and X₁ is 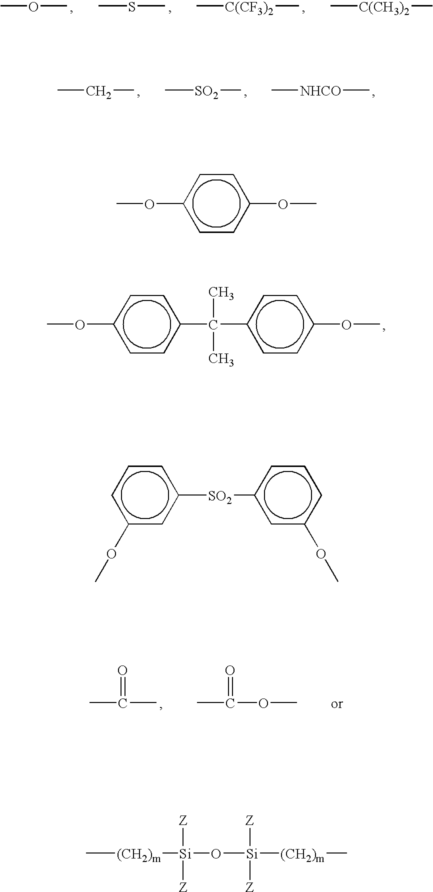
wherein m is an integer of 1-20, and Z is H or methyl.

7. The composition as claimed in claim 3, wherein Ar₂ is 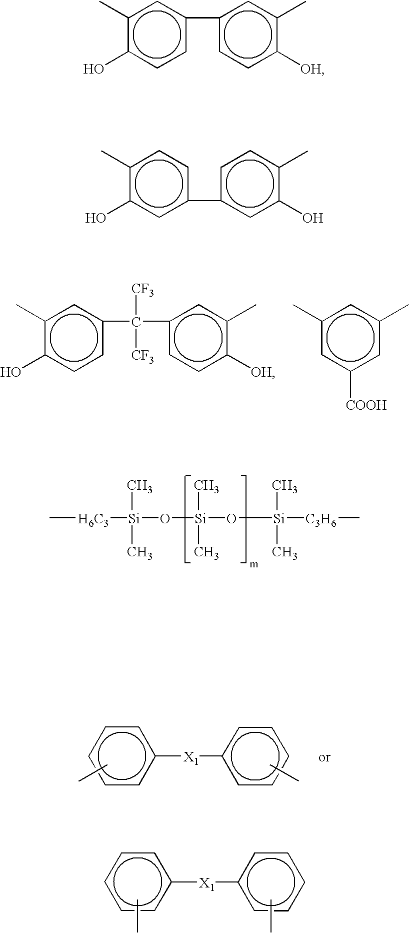 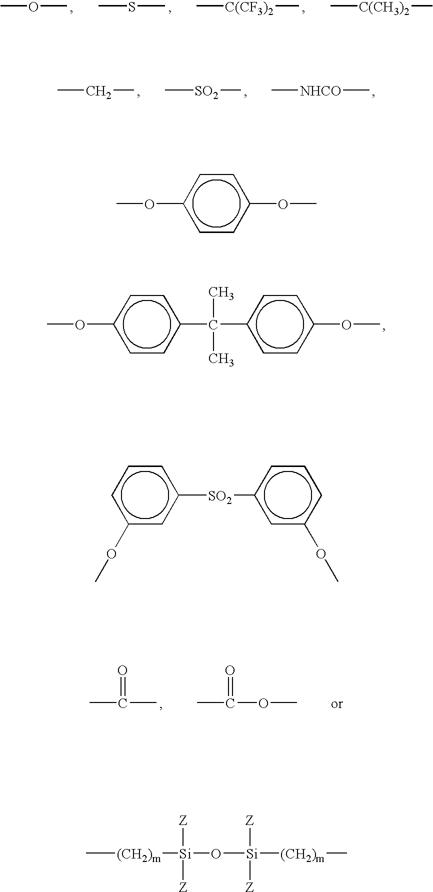
wherein m is an integer of 1-20, and Z is H or methyl.

8. The composition as claimed in claim 2, wherein the amount of the component (b) is 5-25 parts by weight per 100 parts by weight of the component (a) in the composition.

9. The composition as claimed in claim 1, wherein said compound having a phenolic hydroxyl group (b) has the following structure: 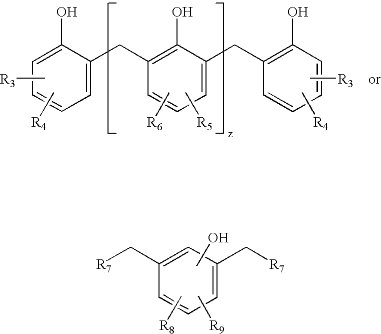
wherein R₃ to R₉ independently are H, —OH group, C₁-C₂₀ alkyl or C₄-C₂₀ cycloaliphatic group, and z is an integer of 0-5.

10. The composition as claimed in claim 9, wherein said compound having a phenolic hydroxyl group (b) is:

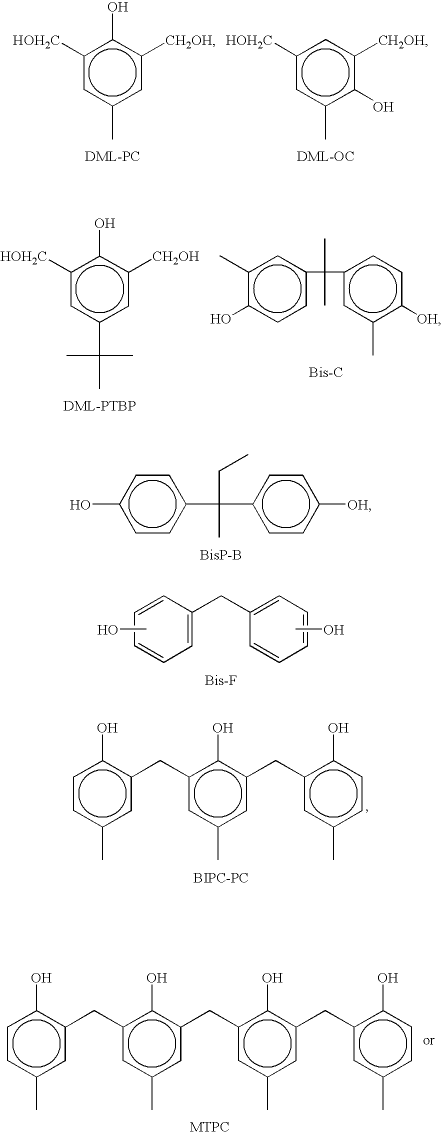

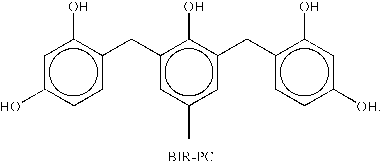

11. The composition as claimed in claim 1, wherein the component (c) as a photosensitive agent has the following structure: 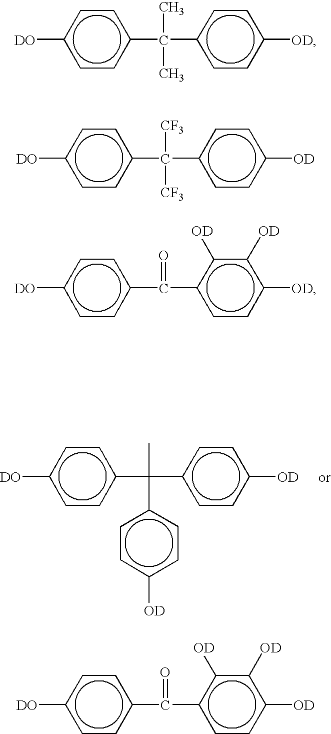
wherein D of each occurrence is hydrogen, 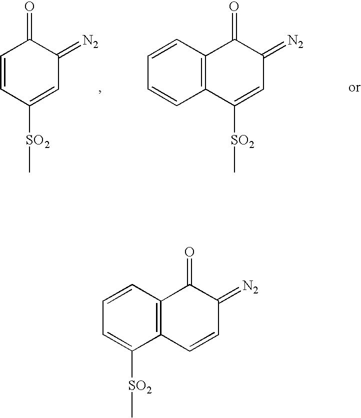
provided that not all occurrences of D are hydrogen.

12. The composition as claimed in claim 1, wherein the total weight of components (a), (b) and (c) is 5-50% of the total weight of said composition.

13. The composition as claimed in claim 1, wherein said organic solvent is N-methyl-2-pyrrolidone, γ-butyrolactone, or ethyl lactate.
